(19) United States
(12) Patent Application Publication
(10) Pub. No.: US 2006/0020938 A1
(43) Pub. Date: Jan. 26, 2006

(54) Method, article of manufacture and apparatus for updating software in a consumer device

(76) Inventors: Albert Fitzgerald Elcock, Havertown, PA (US); Dave Bjordammen, Blue Bell, PA (US); John Kamieniecki, Lafayette Hill, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/894,660

(22) Filed: Jul. 20, 2004

(51) Int. Cl. G06F 9/445

(52) U.S. Cl. 717/178

(57) ABSTRACT

A method for updating a plurality of software objects 62, 64 associated with a first consumer device 14 is operable in a broadband communication system 10 having a server 24 responsive to a plurality of consumer devices via a network. The method includes arranging for receipt of a message 55 by the first consumer device 14, the message 55 identifying the plurality of software objects 62, 64; and based on the message 55, arranging for download of the plurality of software objects 62, 64 from the server 24 to the first consumer device 14.

### FIELD

Aspects of this invention relate generally to automatic software updating, and, more particularly, to methods, articles of manufacture, and apparatuses for updating a plurality of software objects associated with a consumer device operable in a broadband communication system, such as a subscription television system.

### BACKGROUND

Program providers such as multiple system operators, television networks and stations, studios, wireless service providers, and Internet broadcasters/service providers, among others, operate broadband communication systems, delivering programming to consumers over networks via digital or analog signals. Software-configurable consumer devices, such as set-top boxes, media centers, and personal computers, are adapted to receive and render delivered programming. Consumer devices increasingly include as subsystems, or are in communication with, other software-configurable components, such as external hard drives, audio/video receivers, digital video disk (“DVD”) players, compact disk (“CD”) players, MP3 players, video cassette recorders (“VCRs”), modems, gateways, routers, wireless access points, and other devices and products.

Software objects perform many basic functions of consumer devices (and the subsystems or extensions thereof), such as providing operating systems, application programs, and user interfaces. For many well-known reasons, existing software objects are regularly replaced with updated software objects. In a cable communication system, software objects associated with a consumer device, such as a set-top box, may be updated via a network, such as a hybrid fiber-optic/coax network, by downloading the software objects from remote servers, such as download servers associated with a headend, to the consumer device. If multiple software objects are to be downloaded to the consumer device, multiple messages, which provide information regarding the individual software objects to be downloaded, and which may include the software objects themselves, are typically created, conveyed and coordinated by the remote server(s). When the downloaded software objects are to be installed in a predetermined order, both the management of multiple messages, and logic/state transitions of the server(s) and/or the consumer device may be complex and/or consume excessive bandwidth in the network. Such complexity may be especially increased in a one-way communication environment.

Moreover, software objects are typically downloaded from remote servers to consumer devices in a point-to-point manner—that is, a downloaded software object is installed and used by the consumer device that receives the downloaded software object. Using point-to-point download techniques with a consumer device that includes other consumer devices as subsystems or extensions thereof may further complicate the process of automatically updating software objects associated with the consumer device.

There are therefore needs for methods, apparatuses, and articles of manufacture, operable in a broadband communication system, such as a subscription television system that may support only one-way communication with a consumer device, for updating multiple software objects associated with the consumer device, which methods, apparatuses, and articles of manufacture provide a protocol for specifying an order for downloading software objects to the consumer device, and which allow the consumer device to act as a proxy for other consumer devices that may be in communication therewith.

### SUMMARY

According to one aspect of the present invention, a method for updating a plurality of software objects associated with at least a first consumer device is operable in a broadband communication system having a server responsive to a plurality of consumer devices via a network. The method includes arranging for receipt of a message by the first consumer device, the message identifying the plurality of software objects and specifying an order for installing the plurality of software objects; and based on the message, arranging for download of the plurality of software objects from the server to the first consumer device.

In accordance with another aspect of the invention, the method further includes the step of transmitting the plurality of software objects to at least the first consumer device over at least one channel.

In accordance with another aspect of the invention, the channel comprises an in-band channel.

In accordance with another aspect of the invention, the channel comprises an out-of-band channel.

In accordance with another aspect of the invention, the channel comprises a plurality of channels.

In accordance with another aspect of the invention, the plurality of channels includes at least one in-band channel and at least one out-of-band channel.

In accordance with another aspect of the invention, the message associates each of the plurality of software objects with a destination device.

In accordance with another aspect of the invention, the first consumer device is a proxy for a second consumer device to which at least one of the software objects are to be downloaded.

In accordance with another aspect of the invention, the first consumer device is a proxy for the destination device to which the software objects are to be downloaded.

In accordance with another aspect of the invention, the step of arranging for receipt of the message comprises the step of initiating generation and receipt of the message by the server.

In accordance with another aspect of the invention, the step of arranging for receipt of the message comprises the step of initiating receipt of the message by the first consumer device. The step of arranging for download of the plurality of software objects may either include producing, on a designated channel, the plurality of software objects for download from the server to the first consumer device, or may include the steps of tuning to a designated channel, downloading the plurality of software objects from the server to the first consumer device via the designated channel, and arranging for installation of the plurality of software objects in the specified order.

The first consumer device may be responsive to a second consumer device, such as a cable modem, a DVD player, or a wireless access point, and the message may associate each of the plurality of software objects with a destination device. The step of downloading may further include the steps of downloading a first software object and downloading a second software object. Prior to downloading the second software object, the destination device associated with the first software object may be determined, and if the first software object is not ready for installation, it may be saved in a buffer.

The step of arranging for installation may further include, when the destination device is the second consumer device, delivering (via a wireless protocol, a Bluetooth protocol, or a USB protocol) the first software object from the first consumer device to the second consumer device, and the first consumer device may act as a proxy for the second consumer device.

### BRIEF DESCRIPTION OF THE DRAWINGS

FIG. 1 is a block diagram of a broadband communication system, in which various aspects of the present invention may be used.

FIG. 2 is a block diagram of a consumer device responsive to the broadband communication system shown in FIG. 1, in which various aspects of the present invention may be used.

FIG. 3 is a flowchart of a method for updating multiple software objects associated with the consumer device shown in FIG. 2, in accordance with an aspect of the present invention.

FIG. 4 is a flowchart of a method, which may be performed by the consumer device shown in FIG. 2, for updating multiple software objects associated with the consumer device, in accordance with further aspects of the present invention.

### DETAILED DESCRIPTION

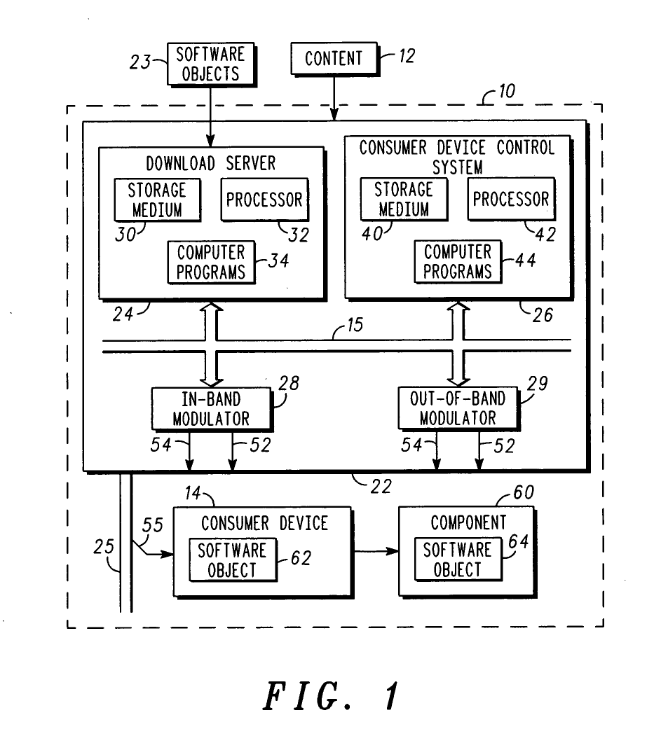

Turning now to the drawings, where like numerals designate like components, FIG. 1 is a block diagram of a broadband communication system 10, which delivers content 12 (such as any pre-recorded or live analog or digital electronic signals representing an image and/or audio, software, or other data, in any format) to one or more of a plurality of software-configurable consumer devices (one consumer device 14, having software object 62 installed thereon, is shown) via headend 22 and network 25. As shown, consumer device 14 is in communication with one or more internal or external software-configurable components/devices-component 60 is shown, having software object 64 installed thereon.

Headend 22 includes, among other things, a download server 24, operative to produce software objects 23 for download, and a consumer device control system 26, which, as those of ordinary skill in the art will recognize, is the primary device in headend 22 that communicates with and controls the operation of consumer device 14. Download server 24 and consumer device control system 26 can communicate with one another over a bus 15 that is also located in headend 22. In addition, both consumer device control system 26 and download server 24 are in communication, via the bus 15, with an in-band modulator 28 and an out-of-band modulator 29. Traffic from in-band modulator 28 and out-of-band modulator 29 may be transmitted to consumer device 14 on either downstream control channel 52, or download channel 54 via either or both of the modulators 28 and 29. Application servers (not shown) may also be in communication with headend 22, to provide a variety of sources for content 12, and/or services, such as interactive television, Internet services, telephone services, video-on-demand services, and the like.

For exemplary purposes, system 10 is a cable communication system operated by a multiple system operator (“MSO”); content 12 is a digital or analog programming source supplied by the MSO; consumer device 14 is a set-top box (for example, a digital set-top terminal, such as a DCT 5100, 6100, or 6200 series terminal, available from Motorola, Inc., or a Broadband Media Center product, such as the BMC 9012 series product or the BMC 9022D series product, also available from Motorola, Inc.); component 60 represents one or more software-configurable consumer device(s), internal or external to consumer device 14 (for example, a DOCSIS® cable modem, a digital video or audio recording/playback device, or a wireless access point (which may be used, for example, for communication with devices such as a Web Pad (available from Motorola, Inc.), which provides a user interface for navigating the World Wide Web using a television display)); software objects 62, 64 are application or system software, which are updated and/or replaced, during normal operation of system 10, with one or more software objects 23; network 25 is a hybrid fiber-optic/coax network providing one- or two-way communications services; download server 24 and consumer device control system 26 are one or more servers, internal or external to headend 22, such as the RADD-1000, available from Motorola, Inc., or the DAC-6000, also available from Motorola, Inc., respectively; and in-band modulator 28 and out-of-band modulator 29 are any devices or combinations of devices for implementing one or more communication channels between headend 22 and consumer device 14, such as the SEM-1000, available from Motorola, Inc., or the Motorola OM-1000, also available from Motorola, Inc., respectively. It will be understood, however, that system 10, and elements and connections throughout network 25, may be any public or private, wired or wireless, content transmission infrastructure or technology for delivery of content 12, including but not limited to a fiber-optic network, a coaxial cable network, a satellite network, a cellular network, a wireless network, the Internet, a television network, a radio network, a copper wire network, or any other existing or future transmission infrastructure or technology, or any combination thereof, operated by any type of program provider. Network 25 may also include layers of other networks. It will also be understood that consumer device 14 and component(s) 60 may be any device or combination of wired or wireless devices responsive to system 10 capable of receiving and rendering content 12, either standing alone, or included in other devices, now existing or later developed. Headend 22 may comprise any appropriate collection of devices that may be co-located with one another or distributed over a number of different locations.

Headend 22 receives content 12, and facilitates transfer of content 12 to consumer device 14, via network 25, provisioning consumer services such as interactive television, Internet services, telephone services, video-on-demand services, and other services. Headend 22 has a well-known internal arrangement, including items such as one or more servers (download server 24 and consumer device control system 26, discussed further below, are shown), which in turn include computer-readable storage media, processors, computer programs, and other items, configured in well-known manners using well-known techniques, to implement the functions of headend 22.

Channels (not shown), such as analog and digital upstream (in the case where system 10 supports two-way communication) and downstream channels, are controlled by headend 22 using well-known methods and techniques. Channels carry signals and data to and from consumer device 14.

In-band modulator 28 may receive data in various forms, including analog or digital video/audio content, control data, or download object data.

In one arrangement, consumer device control system 26 operates to send a message 55, such as an entitlement management message (discussed further below), to consumer device 14. While FIG. 1 shows message 55 being provided to consumer control system 26 as an out-of-band signal via out-of-band modulator 29, message 55 may alternatively be directed to the consumer control system 26 as an in-band signal via in-band modulator 28. Alternatively, message 55 may even be provided to consumer control system 26 in part via in-band modulator 28 and in part via out-of-band modulator 29. Message 55 instructs consumer device 14 on the updating and/or replacement of software objects 62, 64 with one or more software objects 23. Communication protocols utilized on downstream control channel 52 and download channel 54 may either be standard protocols (such as the protocol/messaging scheme defined by the OpenCable™ initiative, managed by the Advanced Platforms and Services group at CableLabs®) or proprietary protocols, and any suitable transport streams (for example, Moving Picture Experts Group (“MPEG”) transport streams) may be used to carry communications, such as messages, from headend 22 to consumer device 14.

Out-of-band modulator 29 operates to produce software objects 23 to consumer device 14 for downloading, via downstream channel 54. Downstream channel 54 may be implemented using a data carousel, such as the Digital Storage Media-Command and Control (“DSM-CC”) Data Carousel, or the DSM-CC Object Carousel, based on international standard ISO/EEC 13818-6 for download object carousels. Alternatively, downstream channel 54 may be implemented using two-way IP protocols, such as file transfer protocol (“FTP”) or trivial FTP (“TFTP”), or using a proprietary messaging scheme carried over an MPEG transport stream.

Download server 24, which may include one or more servers, is operative to communicate with consumer device control system 26 and consumer device 14, to perform certain aspects of the process (discussed further below) of updating software objects 62, 64 associated with consumer device 14 with multiple software objects 23. More specifically, during operation, download server 24 makes software objects 23, which correspond to different devices and applications, continuously available for download—via in-band modulator 28 and/or out-of-band modulator 29—on a data carousel. Different versions of software objects may be carouselled to accommodate different consumer devices.

As shown, download server 24 is a server having a well-known internal arrangement, including items such as a computer-readable storage medium 30 (which may be one or more types of memory, such as read only memory (“ROM”), random access memory (“RAM”), magnetic, optical or other storage devices, or another type of memory), a processor 32, and computer programs 34. Download server 24 may further include other well-known elements (not shown), configured in well-known manners using well-known techniques, such as: physical memory; additional storage devices; disk controllers; network adapters or interfaces; and human-device interfaces.

Processor 32 is responsive to computer-readable storage medium 30 and to computer programs 34. Computer programs 34 are generally organized into functional components, stored in computer-readable storage medium 30, and implemented according to well-known software engineering practices for component-based software development. It will be understood, however, that functions of download server 24 may be carried out using hardware, software, firmware, or any combination thereof.

Computer programs 34 include components that perform functions relating to the production of software objects 23 for download from download server 24 to consumer device 14. A network/communications interface function (not shown), for example, may support a modem or other network connection support device(s) or program(s), and may be responsive to, and responsible for, mechanics of communication between download server 24 and other devices, such as possibly consumer device control system 26, consumer device 14, out-of-band modulator 29 and in-band modulator 28. Communication between download server 24 and other devices or functions may occur using well-known methods and any desired protocol(s). A software object management function (not shown) may be responsible for producing software objects 23 for download to or by consumer device 14and for providing information regarding software objects 23 to consumer device control system 26 and consumer device 14.

Computer-readable storage medium 30 may also store software objects 23, and/or information about individual software objects 23, or groups of software objects 23, such as: unique software object identifiers; the consumer device(s) configured to use and/or install a particular software object; an order in which each software object usable on the same consumer device(s) should be installed on such device(s); a version of a particular software objects; a size of a particular software object (for example, the number of bytes); the type of memory in which a particular software objects should be stored (for example, flash memory, ROM, RAM, hard disk, or another memory type); and where a particular software object is located within the data carousel.

Consumer device control system 26, which may include one or more servers, is operative to communicate with download server 24 and consumer device 14, to perform certain aspects of the process (discussed further below) of updating software objects 62, 64 associated with consumer device 14 with multiple software objects 23. More specifically, consumer device control system 26 communicates the availability of, and information regarding, updated software objects 23 to consumer device 14, via an entitlement management message (also discussed further below).

As shown, consumer device control system 26 is a server having a well-known internal arrangement, including items such as a computer-readable storage medium 40 (which may be one or more types of memory, such as ROM, RAM, magnetic, optical or other storage devices, or another type of memory), a processor 42, and computer programs 44. Consumer device control system 26 may further include other well-known elements (not shown), configured in well-known manners using well-known techniques, such as: physical memory; additional storage devices; disk controllers; network adapters or interfaces; and human-device interfaces.

Computer-readable storage medium 40 stores, among other things, unique identifiers for consumer devices, for example, serial numbers, internet protocol addresses, account numbers, passwords, personal identification numbers, and other consumer device identifiers used to direct communications to, and authenticate communications with, consumer device 14. Like computer-readable storage medium 30, computer-readable storage medium 40 may also store information about individual software objects 23, or groups of software objects 23, such as: unique software object identifiers; the consumer device(s) configured to use and/or install a particular software object; an order in which each software object usable on the same consumer device(s) should be installed on such device(s); a version of a particular software objects; a size of a particular software object (for example, the number of bytes); the type of memory in which a particular software objects should be stored (for example, flash memory, ROM, RAM, hard disk, or another memory type); and where a particular software object is located within the data carousel.

Processor 42 is responsive to computer-readable storage medium 40 and to computer programs 44. Computer programs 44 are generally organized into functional components, stored in computer-readable storage medium 40, and implemented according to well-known software engineering practices for component-based software development. It will be understood, however, that functions of consumer device control system 26 may be carried out using hardware, software, firmware, or any combination thereof.

Computer programs 44 include components that perform functions relating to the transmission of message 55 to consumer device 14 regarding updating software objects 62, 64 associated with consumer device 14 with multiple software objects 23. A network/communications interface function (not shown), for example, may support a modem or other network connection support device(s) or program(s), and may be responsive to, and responsible for, mechanics of communication between consumer device control system 26 and other devices, such as download server 24, consumer device 14, and/or in-band modulator 28. Communication between consumer device control system 26 and other devices or functions may occur using well-known methods and any desired protocol(s). A message management function (not shown) may be responsible for creation of message 55, identifying multiple software objects 23 to be installed in a particular order on consumer device 14. The message management function arranges for consumer device 14 to receive message 55 by transmitting message 55 to consumer device 14 via in-band modulator 28 (and/or out-of-band modulator 29) and downstream control channel 52. Message 55 may be transmitted periodically, continuously, or on a custom basis, using either in-band or out-of-band techniques, and may be compressed, encoded, encrypted or otherwise modified prior to transmission.

Message 55 has a general structure including a header and a data field. The header may include information such as addressing information for consumer devices—the addressing information may be global, group or individual addressing. The data field includes an order-dependent list of software objects, each tagged with a destination device, such as consumer device 14 or component 60, and information regarding where each software object is located, for example, a location in the data stream on downstream channel 54. Further information describing each software object and/or its destination device may also be included in the entitlement management message—unique software object identifiers, software object version codes, identifiers regarding the type of memory the software object should be stored in, and the size of the software object, for example. A sample entitlement management message includes addressing information, object descriptions and destinations, and object load order, and may include the following fields: load order; number of objects; and object identifiers. Examples of object identifiers include object names, object version codes, target devices, identifiers regarding the type of memory the objects should be stored in, and object sizes.

FIG. 2 is a simplified block diagram of consumer device 14, in which various aspects of the present invention may be used. As shown, consumer device 14 is in communication with component 60, which, as shown and described in connection with FIG. 1, may be one or more software-configurable consumer devices, for example, a DOCSIS® cable modem, a digital video or audio recording/playback device, a wireless access point (or any device responsive thereto), or any other consumer device now known or later developed, internal or external to consumer device 14. As shown, component(s) 60 stores software object 64 in a memory (not shown), which may be updated with one or more software objects 23, as discussed further below. Communication between consumer device 14 and component(s) 60 may occur via any number of well-known communication methods and/or protocols, such as wireless LAN, Bluetooth, or a serial bus implementation, such as USB, or may occur via an external network connection/communication interface 259, which supports devices such as modems, streaming media players and other network connection support devices and/or software.

External network connection/communication interface 259 may be coupled through local or wide area networks (not shown) to program providers and providers of other content. External network connection/communication interface 259 is also responsive to, and responsible for, mechanics of communication between consumer device 14 and/or component(s) 60 and other devices, such as download server 24 (shown in FIG. 1) and consumer device control system 26 (also shown in FIG. 1), out-of-band modulator 29, and in-band modulator 28.

Consumer device 14 further includes a tuner 243, which tunes to a channel signal, such as channel 52 or 54, or another channel. As is well known, consumers may select certain channels, such as those that carry content 12, via user interface 255. User interface 255 may be any type of known or future device or technology allowing the consumer to select content 12, such as channels or programming, the consumer wishes to receive, such as a remote control, mouse, microphone, keyboard, or display.

Demodulators/decoders 244 are responsive to in-band tuner 243. Demodulators may be any type of demodulators responsive to receive digital or analog versions of a channel signal. Decoders are operative for decoding information, such as video information, and converting it into a digital representation of the received information. Internal arrangements of demodulators/decoders 244 are well known, and may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control.

Other well-known devices or functions (not shown) that may be included in consumer device 14 include encoders and multi-media processors, operative to perform predetermined coding techniques to arrange information into desired formats—for example, encrypted, decrypted, displayable or otherwise usable formats.

Consumer device 14 further includes a bus 202, a storage medium 204, a processor 206 and computer programs 208, which are illustrated functionally. Storage medium 204 may be any local or remote device capable of storing data, including a non-volatile memory, such as a hard disk drive, a ROM, a videocassette recorder tape, all types of compact disks and digital videodisks, a magnetic tape, an optical storage medium, a home router, or a server; or a volatile memory, such as a flash memory or a random access memory; or any other data storage medium, now known or later developed. Storage medium 204 stores, among other things, computer programs 208, including software object 62, which may be updated by one or more software objects 23.

When loaded into a processor, such as processor 206, and executed, computer programs 208 perform various functions of consumer device 14, as set forth herein. Computer programs 208 include one or more components that perform functions relating to the download (from download server 24) and management of software objects 23 in accordance with the entitlement management message received from consumer device control system 26. A download management function (not shown) may be responsible for implementing a method for updating one or more software objects associated with consumer device 14 and/or component 60, such as software objects 62 and 64, with multiple software objects 23.

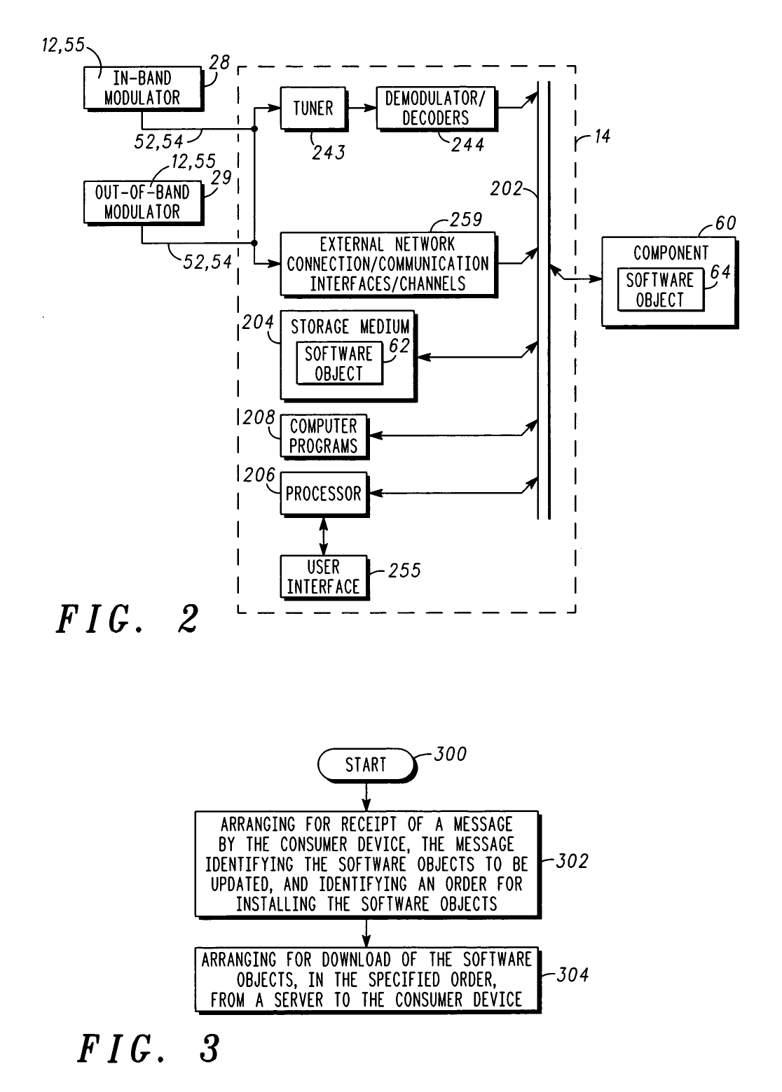

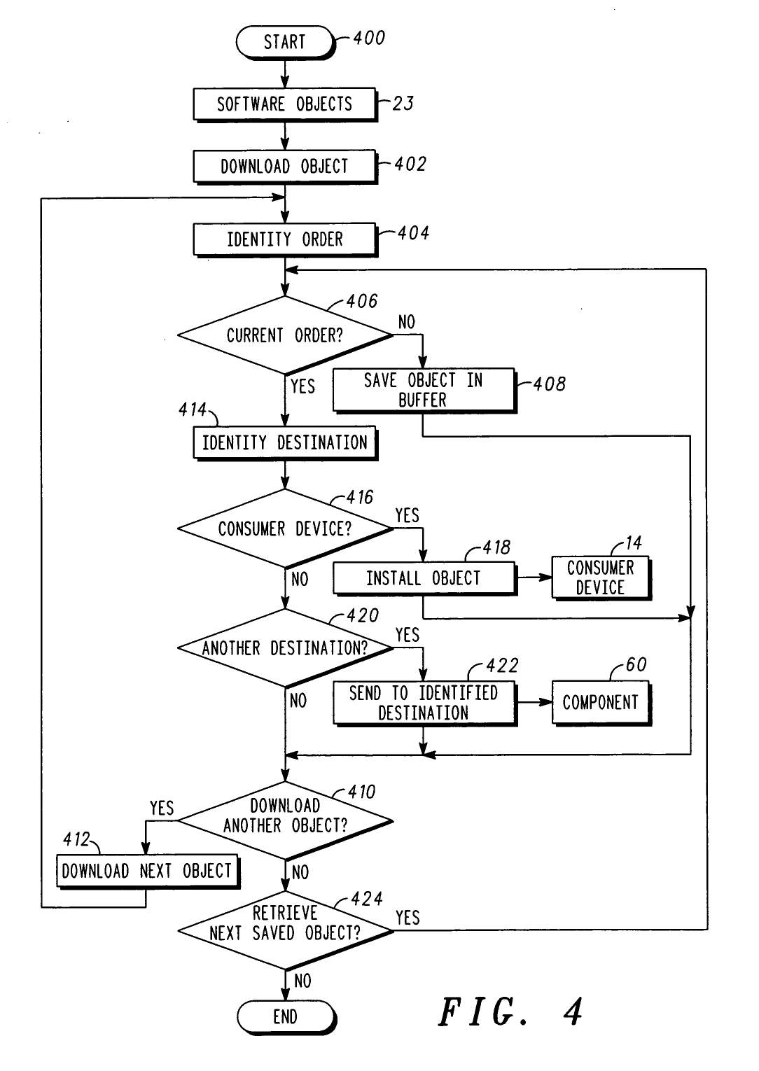

With continuing reference to FIGS. 1 and 2, FIG. 3 is a flowchart of a method, operable in a broadband communications system, such as cable communication system 10, for updating multiple software objects, such as software objects 62 and 64, associated with a consumer device, such as consumer device 14. The broadband communication system includes a server, such as download server 24 and/or consumer device control system 26. The method begins at block 300, and continues at block 302, where it is arranged for receipt of a message by the consumer device 14. The message identifies the software objects to be updated and specifies an order for installing the software objects.

The message may be message 55, an entitlement management message, prepared and transmitted over downstream control channel 52, for example, to consumer device 14 via the message management function of consumer device control system 26. Message 55 may be stored in memory at consumer device 14, executed as received, or a combination thereof.

Consumer device control system 26 may coordinate with the software object management function of download server 24 to supply certain information within message 55. Message 55 includes an order-dependent list of software objects, each tagged with a destination device. The destination device may be consumer device 14, or another consumer device in communication therewith, such as component(s) 60. As discussed above, message 55 may further include information such as addressing information for consumer device 14—the addressing information may be global, group or individual addressing. Message 55 may still further include information regarding where each software object is located, for example, a location in the data stream on downstream channel 54, unique software object identifiers, software object version codes, identifiers regarding the type of memory the software object should be stored in, and the size of the software object.

At block 304, based on the message, it is arranged for the download of the software objects in the specified order from the server. It will be understood that the software objects and the control message may be transmitted on the same channel or on different channels. The download management function of download server 24—which may coordinate with the message management function of consumer device control system 26—may coordinate the production of software objects for download via out-of-band modulator 29, and/or in-band modulator 28, and download channel 54.

Consumer device 14 tunes to download channel 54, and downloads the software objects from download server 24 based on information in message 55. Any well-known methods and techniques may be used for connection to download channel 54/download server 24, and such connection may occur automatically or under control of consumer device 14 or consumer device(s) 60, or an operator(s) thereof. Software modules 23 may be compressed, encoded, encrypted, or otherwise modified prior to transmission. The download management function of consumer device 14 may arrange for installation of the software objects in the order specified in message 55. The download management function may execute instructions within message 55 directly, or may interpret the content of message 55, and execute other instructions based on the interpreted content.

With continuing reference to FIGS. 1-3, FIG. 4 is a flowchart of a method, which may be performed by the download management function of consumer device 14, for downloading and installing the software objects in the specified order.

The method begins at block 400, and continues at block 402, where a software object (selected from among software objects 23, for example) is downloaded to consumer device 14. Based on the information in message 55 regarding installation order of the software object, an installation order of the software object is identified, at step 404. If, at step 406, the identified installation order indicates that the software object is not ready for installation, then the software object may be stored in a buffer (for example, storage medium 204), at step 408, and the method determines if, based on message 55, another software object is to be downloaded, at step 410. If another software object is to be downloaded, then the next software object is downloaded at step 412, and the method returns to step 404, where the installation order of the next software object is identified.

If, however, the identified installation order at step 406 indicates that the software object is ready for installation, then a destination device associated with the software object is determined, at step 414. The destination device may be consumer device 14, or a consumer device represented by component 60, such as a DOCSIS® cable modem, a digital video or audio recording/playback device, a wireless access point (or any device responsive thereto), or any other consumer device now known or later developed, internal or external to consumer device 14. If, at step 416, it is determined that the destination device is the downloading consumer device, then the software object is installed on consumer device 14, at step 418, and the method determines if, based on message 55, another software object is to be downloaded, at step 410. If, at step 410, the method indicates that another software object is to be downloaded, then the next software object is downloaded at step 412, and the method returns to step 404, where the installation order of the next software object is identified.

If, however, it is determined at step 416 that the software object is not for installation on the downloading consumer device, then at step 420, the different destination device, such as a component 60, is identified, and the software object is sent, at step 422, to the identified destination device. In this case, because it is the initial device that receives the software object from the headend 22, the consumer device 14 serves as a proxy for the identified destination device. Transmission of the software object from consumer device 14 and the identified destination device may occur via any number of well-known communication methods and/or protocols, such as wireless LAN, Bluetooth, or a serial bus implementation, such as USB, or may occur via an external network connection/communication interface 259. If consumer device 14 and component 60 are not in communication with one another when the consumer device 14 receives a software object intended for component 60, the software object may be buffered in consumer device 14 until communication is established. Next, at step 410, if the method indicates that another software object is to be downloaded, then the next software object is downloaded at step 412, and the method returns to step 404, where the installation order of the next software object is identified.

When, at step 410, there are no further software objects to be downloaded, the software objects buffered at step 408, if any, are retrieved, at step 424. For each retrieved software object, the method returns to step 406, where it is determined whether the identified installation order indicates that the retrieved software object is ready for installation. If the retrieved software object is not ready for installation, it is returned to the buffer, at step 408. If the retrieved software object is ready for installation, the method continues from step 414, where the destination device associated with the software object is determined. The method continues until all software objects identified in message 55 have been installed.

Thus, a single message may be used to instruct a consumer device regarding the downloading and installation, in a predetermined order, of multiple software objects. Further, the downloading consumer device may function as a proxy for other consumer devices in communication therewith-software objects may be downloaded by one consumer device, and installed and used by another consumer device. The methods, apparatuses and articles of manufacture described herein are operable in a one- or two-way broadband communication system. The software update process may be initiated by system 10 or consumer devices therein, upon any desired trigger(s).

Although a specific architecture has been described herein, including specific functional elements and relationships, it is contemplated that the systems and methods herein may be implemented in a variety of ways. For example, functional elements may be packaged together or individually, or may be implemented by fewer, more or different devices, and may be either integrated within other products, or adapted to work with other products externally. For example, system 10 may be configured differently, or contain different or additional components, and download server 24 and/or consumer device control system 26 may be implemented together or separately, within or separate from, headend 22. When one element is indicated as being responsive to another element, the elements may be directly or indirectly coupled.

It will also be appreciated that aspects of the present invention are not limited to any specific embodiments of computer software or signal processing methods. For example, one or more processors packaged together or with other elements of headend 22 or consumer device 14 may implement functions of processors 32, 42, or 206, respectively, in a variety of ways. It will also be appreciated that computer programs 34, 44, and 208, and other functions indicated for implementation using computer programs, may be any stored instructions, in one or more parts, that electronically control functions set forth herein, and may be used or implemented by one or more elements, including one or more processors.

It will further be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A method, operable in a broadband communication system having a server responsive to a plurality of consumer devices via a network, for updating a plurality of software objects associated with at least a first consumer device, the method comprising:
arranging for receipt of a message by the first consumer device, the message identifying the plurality of software objects and specifying an order for installing the plurality of software objects; and
based on the message, arranging for download of the plurality of software objects from the server to the first consumer device.

2. The method of claim 1 further comprising the step of transmitting the plurality of software objects to at least the first consumer device over at least one channel.

3. The method of claim 2 wherein said at least one channel comprises an in-band channel.

4. The method of claim 2 wherein said at least one channel comprises an out-of-band channel.

5. The method of claim 2 wherein said at least one channel comprises a plurality of channels.

6. The method of claim 5 wherein said plurality of channels includes at least one in-band channel and at least one out-of-band channel.

7. The method of claim 1 wherein the message associates each of the plurality of software objects with a destination device.

8. The method of claim 1 wherein said first consumer device is a proxy for a second consumer device to which at least one of the software objects are to be downloaded.

9. The method of claim 7 wherein said first consumer device is a proxy for the destination device to which the software objects are to be downloaded.

10. The method of claim 1 wherein the step of arranging for receipt of the message comprises the step of initiating generation and receipt of the message by said server.

11. The method of claim 1 wherein the step of arranging for receipt of the message comprises the step of initiating receipt of the message by said first consumer device.

12. The method according to claim 1,
wherein the step of arranging for receipt further comprises:
transmitting the message to the first consumer device, and
wherein the step of arranging for download further comprises:
after transmitting the message, producing, on one or more designated channels, the plurality of software objects for download from the server to the first consumer device.

13. The method according to claim 1,
wherein the step of arranging for receipt further comprises:
receiving the message by the first consumer device, and
wherein the step of arranging for download further comprises:
tuning to one or more designated channels;
downloading the plurality of software objects from the server to the first consumer device via said one or more designated channels; and
arranging for installation of the plurality of software objects in the specified order.

14. The method of claim 13 wherein the installation arranging step further comprises the step of determining a destination device for which at least one of the software objects are located and providing said at least one software object to the destination device from the first consumer device

15. The method according to claim 13, wherein the message associates each of the plurality of software objects with a destination device.

16. The method according to claim 15, wherein the first consumer device is responsive to a second consumer device.

17. The method according to claim 16, wherein the second consumer device comprises one of a cable modem; a DVD player; and a wireless access point.

18. The method according to claim 1, wherein the step of downloading further comprises:
downloading a first software object;
based on the message, identifying an installation order of the first software object; and
downloading a second software object.

19. The method according to claim 16, wherein the step of downloading further comprises:
downloading a first software object;
based on the message, identifying an installation order of the first software object; and
downloading a second software object.

20. The method according to claim 19, further comprising:
prior to downloading the second software object, when the identified installation order indicates that the first software object is ready for installation, determining the destination device associated with the first software object.

21. The method according to claim 20, wherein the step of arranging for installation further comprises:
when the destination device comprises the second consumer device, delivering the first software object from the first consumer device to the second consumer device, the first consumer device acting as a proxy for the second consumer device.

22. The method according to claim 21, wherein the step of delivering comprises delivering using one of a wireless protocol, a Bluetooth protocol, and a USB protocol for delivery.

23. The method according to claim 20, wherein the step of arranging for installation further comprises:
when the destination device comprises the first consumer device, installing the first software object on the first consumer device.

24. The method according to claim 19, further comprising:
prior to downloading the second software object, when the identified installation order indicates that the first software object is not ready for installation, saving the first software object in a buffer.

25. A computer-readable medium encoded with a computer program which, when loaded into a processor, implements the method of claim 1.

26. The computer-readable medium according to claim 25, wherein the processor is associated with the first consumer device.

27. The computer-readable medium according to claim 25, wherein the processor is associated with the server.

28. An apparatus for updating a plurality of software objects associated with at least a first consumer device, the apparatus comprising:
a computer-readable storage medium; and
a processor responsive to the computer-readable storage medium and to a software program, the software program, when loaded into the processor, operative to perform a method comprising:
arranging for receipt of a message by the first consumer device, the message identifying the plurality of software objects and specifying an order for installing the plurality of software objects; and
based on the message, arranging for download of the plurality of software objects, from the server to the first consumer device.

29. The apparatus according to claim 28, wherein the processor is associated with the consumer device, and wherein the consumer device comprises a set-top box.

30. The apparatus according to claim 28, wherein the processor is associated with a download server in a subscription television system.

31. The apparatus of claim 28 further comprising the step of transmitting the plurality of software objects to at least the first consumer device over at least one channel.

32. The apparatus of claim 31 wherein said at least one channel comprises an in-band channel.

33. The apparatus of claim 31 wherein said at least one channel comprises an out-of-band channel.

34. The apparatus of claim 31 wherein said at least one channel comprises a plurality of channels.

35. The apparatus of claim 34 wherein said plurality of channels includes at least one in-band channel and at least one out-of-band channel.

36. The apparatus of claim 28 wherein the message associates each of the plurality of software objects with a destination device.

37. The apparatus of claim 28 wherein said first consumer device is a proxy for a second consumer device to which at least one of the software objects are to be downloaded.

38. The apparatus of claim 36 wherein said first consumer device is a proxy for the destination device to which the software objects are to be downloaded.

39. The apparatus of claim 30 wherein the step of arranging for receipt of the message comprises the step of initiating generation and receipt of the message by said server.

40. The apparatus of claim 28 wherein the step of arranging for receipt of the message comprises the step of initiating receipt of the message by said first consumer device.

41. The apparatus according to claim 32, wherein the in-band channel carries the message via an MPEG transport stream.

42. The apparatus according to claim 31, wherein said at least one channel comprises a data carousel.

43. The apparatus according to claim 28, wherein the message comprises an entitlement management message.

44. The apparatus according to claim 28, wherein each of the plurality of software objects comprise one of an application software object and a system software object.

45. The method of claim 9 wherein said software objects intended for the destination device are buffered in the first consumer device if the first consumer device and the destination device are not in communication with one another.

46. The method of claim 45 wherein said software objects are downloaded from the first consumer device to the destination device when communication therebetween is established.
